(19) United States
(12) Patent Application Publication
(10) Pub. No.: US 2003/0085251 A1
(43) Pub. Date: May 8, 2003

(54) Stapler construction

(76) Inventor: Giorgio Balma, Voghera (IT)

Correspondence Address: James V. Costigan, Esq., Hedman & Costigan, P.C., Suite 2003, 1185 Avenue of the Americas, New York, NY, 10036-2646, US

(21) Appl. No.: 10/272,443

(22) Filed: Oct. 15, 2002

(30) Foreign Application Priority Data
Oct. 16, 2001 (IT) MI2001U-000549

(51) Int. Cl. B25C 5/02

(52) U.S. Cl. 227/134

(57) ABSTRACT

A stapler comprises a loader device pivoted to a bottom plate and including the mechanisms for feeding the staples and operating the stapler, the loader device being, at least partially, engaged in a contoured handle body, the bottom plate being coupled to a bottom body so designed that the stapler can be used both as a gripper, by gripping the two bodies by a hand, and as a so-called table stapler, by causing the stapler to bear on a bottom plane.

### BACKGROUND OF THE INVENTION

The present invention relates to an improved stapler construction.

Are already known staples, of the so-called gripper type, comprising a loader pivoted to a plate thereby, by gripping by a hand the stapler as a gripper, it is possible to clamp the hand to operate the stapler and apply a staple.

Yet other prior staplers, the so-called table staplers, are conventionally use with staples having a size larger than that of the gripper stapler staples, and are designed to be operated in an ontable bearing condition, by operating the top movable portion of the stapler, comprising the stapler loader body.

The mentioned table staplers, of a less size, are preferred since they use staples having a size larger than those of the staples used in gripper staplers thereby allowing an operator to staple or stitch together larger thickness sheets.

However, the table staplers are specifically designed to be used in an on a table bearing condition and it is not possible to use them as a gripper stapler without a bearing surface.

### SUMMARY OF THE INVENTION

Accordingly, the aim of the present invention is to provide a stapler construction which is improved with respect to like prior staplers.

Within the scope of the above mentioned aim, a main object of the present invention is to provide such a table stapler construction which can be easily used as a gripper stapler, without providing a bearing surface or table.

Another object of the present invention is to provide such a stapler construction which is more efficient in operation than prior staplers specifically designed for each specific stapling use.

According to one aspect of the present invention, the above mentioned aim and objects, as well as yet other objects, which will become more apparent hereinafter, are achieved by an improved stapler construction comprising a loader pivoted to a bottom plate and including operating mechanisms for supplying staples and operating the stapler, and being characterized in that said loader is engaged, at least partially, in a contoured handle body, said bottom plate is coupled to a bottom body so designed that said stapler construction can be used both as a gripper stapler, by gripping the two stapler bodies by a hand, and as a table stapler, by supporting a stapler body on a supporting surface.

### BRIEF DESCRIPTION OF THE DRAWINGS

Further characteristics and advantages of the present invention will become more apparent hereinafter from the following detailed disclosure of a preferred, though not exclusive, embodiment of the invention, which is illustrated, by way of an indicative but not limitative example, in the accompanying drawings, where:

FIG. 1 is a side-elevation, cross-sectional view, of the improved stapler construction according to the present invention;

FIG. 2 is a top plan view of the stapler construction according to the invention;

FIG. 3 is a further side elevation view illustrating the stapler according to the invention in a vertical position, bearing on a supporting plane or surface; and

FIGS. 4 and 5 illustrate two further side views of two embodiments of the stapler construction according to the invention.

### DESCRIPTION OF THE PREFERRED EMBODIMENTS

With reference to the number references of the above mentioned figures, the stapler construction according to the invention, which has been generally indicated by the reference number 1, comprises a loader 2 pivoted to a bottom plate 3, and including therein the required mechanisms for supplying the staples and operating the stapler, which mechanisms are well known per se and accordingly not herein further disclosed.

According to the invention, the loader 2 is engaged, at least partially, in a handle body 4, preferably made of a plastics material and having an anatomic configuration, to be easily gripped by a hand.

To this end, the bottom plate 3 is coupled to a bottom body 5.

The bottom body 5 is also preferably made of a plastics material and so contoured that it can be easily gripped by a hand, in order to operate the stapler as a gripper stapler.

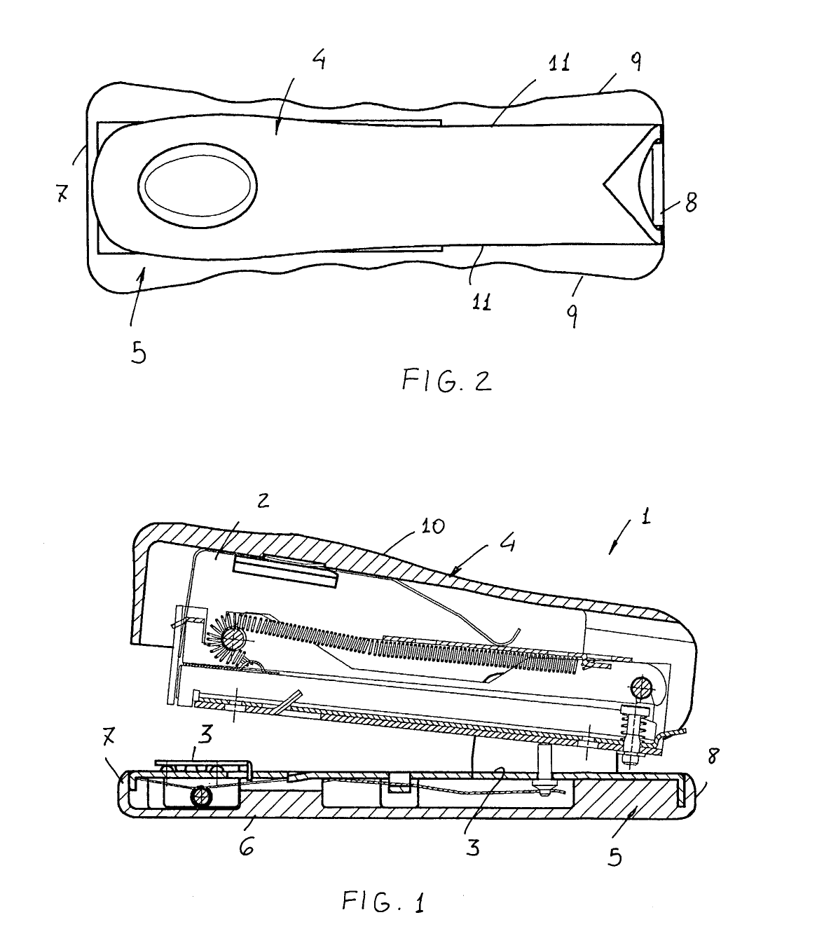

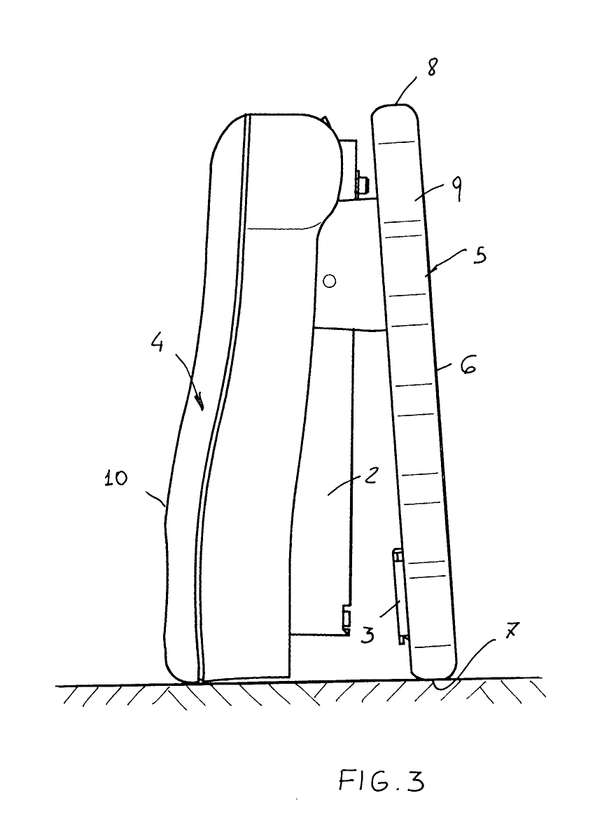

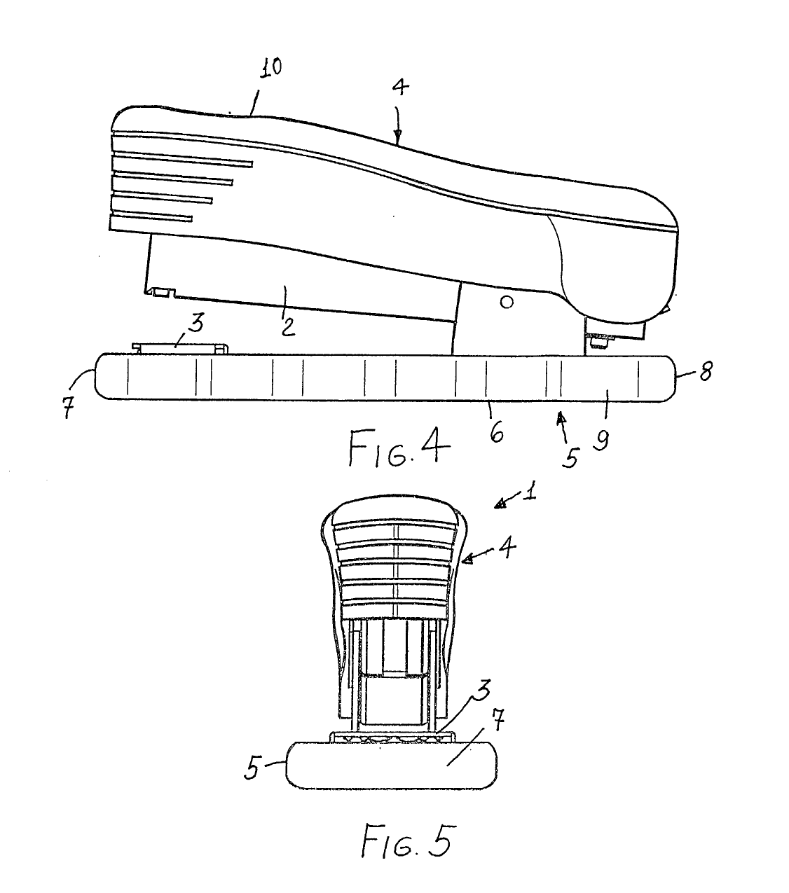

Both the handle body 4 and bottom body 5 are so designed that they allow to bear the stapler on a bearing surface both in a horizontal position, as shown in FIG. 1, and in a vertical position, as shown in FIG. 3.

To use the stapler according to the present invention both as a gripper stapler and a table stapler, the bodies 4 and 5 are, as stated, suitably shaped or contoured.

More specifically, the bottom body 5 is provided with a substantially flat bottom surface 6, meeting with a front surface 7, also flat and so designed as to operate as a stable bearing plane for the stapler in the vertical position of the latter.

The bottom body 5 is moreover provided with a rear surface 8, also of flat configuration, and so designed as to operate as a stable bearing plane for the stapler in its vertical position, turned over with respect to the position shown in FIG. 3.

Finally, the bottom body 5 comprises side surfaces 9 which have an anatomical configuration, thereby they can be used as a handle, for operating the stapler as a gripper stapler.

To that end, the handle body 4 comprises contoured side surfaces 11 and a boss or ridge portion 10 on its top surface, facilitating the gripping by an operator, and allowing the stapler to be easily operated by pressure.

The thus designed stapler construction can be indifferently, and with the same efficiency, used as a table stapler, by bearing the bottom body on a bearing surface, and pressing by a hand on the handle body to operate the stapler, or as a gripper stapler, by gripping the stapler so as to allow the hand to encompass the handle body and bottom body to operate said stapler.

In a non use condition, the stapler can be supported on a table both horizontally, as is shown in FIG. 1, and vertically, as shown in FIG. 3, but even in a turned over condition.

By vertically supporting the stapler, a double advantage is obtained, since, in this position, it will be already ready to be gripped and operated without further handling operations.

Moreover, the stapler can be easily seen in a case of working surfaces supporting a plurality of articles and/or documents.

It has been found that the invention fully achieves the intended aim and objects.

In fact, the invention provides a stapler construction which is very flexible and efficient in operation, since it can be indifferently used either within or without a bearing surface.

In practicing the invention, the used materials, and their contingent size and shapes, can be any, depending on requirements and the status of the art.

1. An improved stapler construction comprising a loader pivoted to a bottom plate and including operating mechanisms for supplying staples and operating the stapler, and being characterized in that said loader is engaged, at least partially, in a contoured handle body, said bottom plate is coupled to a bottom body so designed that said stapler construction can be used both as a gripper stapler, by gripping the two stapler bodies by a hand, and as a table stapler, by supporting a stapler body on a supporting surface.

2. A stapler construction, according to claim 1, characterized in that said bottom base comprises a substantially flat bottom surface meeting with a front flat surface, so designed as to operate as a stable bearing plane for said stapler construction as said stapler construction is arranged in a vertical position.

3. A stapler construction, according to claim 1, characterized in that said bottom base comprises a rear flat surface so designed as to operated as a stable bearing plane for said stapler construction in a vertical position thereof, turned over with respect to the first vertical position.

4. A stapler construction, according to claim 1, characterized in that said bottom body comprises side surfaces which are so anatomically contoured as to operate as a handle, as the stapler construction is used as a gripper stapler.

5. A stapler construction, according to claim 4, characterized in that said handle body comprises contoured side surfaces and a ridge on a top surface thereof to facilitate a gripping of said stapler construction and allowing an operating pressure to be easily applied on said two bodies for operating said stapler construction.
